(19) United States
(12) Patent Application Publication
(10) Pub. No.: US 2025/0274164 A1
(43) Pub. Date: Aug. 28, 2025

(54) INDICATING CRITICAL UPDATES FOR COORDINATED ACCESS POINT MECHANISMS

(71) Applicant: QUALCOMM Incorporated, San Diego, CA (US)

(72) Inventors: Gaurang NAIK, San Diego, CA (US); Abhishek Pramod PATIL, San Diego, CA (US); Alfred ASTERJADHI, San Diego, CA (US); George CHERIAN, San Diego, CA (US); Sai Yiu Duncan HO, San Diego, CA (US); Sanket Sanjay KALAMKAR, San Diego, CA (US); Giovanni CHISCI, San Diego, CA (US); Sherief HELWA, San Diego, CA (US)

(21) Appl. No.: 18/587,410

(22) Filed: Feb. 26, 2024

(51) Int. Cl. H04B 7/024; H04W 28/18

(52) U.S. Cl. CPC H04B 7/024; H04W 28/18

(57) ABSTRACT

This disclosure provides methods, components, devices and systems for indicating critical updates for coordinated access point mechanisms. Various aspects relate generally relate to a field in a frame that may indicate whether the frame comprises updates related to a coordinated access point (CAP) scheme. Various aspects relate more specifically to a CAP parameter change count (CAP-PCC) field or a CAP critical update flag (CAP-CUF) field that may indicate whether a frame comprises updates related to the CAP scheme. In some aspects, the CAP-PCC field, the CAP-CUF field, or both may be communication link-specific or common across one or more communication links between a transmitted access point (AP) using the CAP scheme and one or more wireless stations (STAs). In some aspects, the frame may include (such as via the CAP-PCC field) an indication of an index associated with one or more APs for which the update applies.

### TECHNICAL FIELD

This disclosure relates generally to wireless communication and, more specifically, to indicating critical updates for coordinated access point mechanisms.

### DESCRIPTION OF THE RELATED TECHNOLOGY

Wireless communication networks are widely deployed to provide various types of communication content such as voice, video, packet data, messaging, broadcast, and so on. Some wireless communication networks may be capable of supporting communication with multiple users by sharing the available system resources (such as time, frequency, or power). Further, a wireless communication network may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM), among other examples. Wireless communication devices may communicate in accordance with any one or more of such wireless communication technologies, and may include wireless stations (STAs), wireless access points (APs), user equipment (UEs), network entities, or other wireless nodes.

In some wireless communication networks, one or more APs may communicate according to a coordinated AP scheme. For example, the one or more APs may share one or more resources for transmission opportunities (TXOPs).

### SUMMARY

The systems, methods, and devices of this disclosure each have several innovative aspects, no single one of which is solely responsible for the desirable attributes disclosed herein.

A method for wireless communications by a first wireless access point (AP) is described. The method may include communicating with a second AP according to a coordinated AP (CAP) scheme in accordance with one or more parameters associated with the CAP scheme, receiving a frame including a set of multiple fields, the set of multiple fields including a field including one of a first value or a second value, the first value of the field being indicative of a change in the one or more parameters associated with the CAP scheme, and the second value of the field being indicative of the one or more parameters associated with the CAP scheme remaining the same, decoding one or more additional fields of the set of multiple fields of the frame in accordance with the field including the first value, and communicating with the second AP according to one or more updated parameters associated with the CAP scheme.

A first wireless AP for wireless communications is described. The first wireless AP may include a processing system that includes processor circuitry and memory circuitry that stores code. The processing system may be configured to cause the first wireless AP to communicate with a second AP according to a CAP scheme in accordance with one or more parameters associated with the CAP scheme, receive a frame including a set of multiple fields, the set of multiple fields including a field including one of a first value or a second value, the first value of the field being indicative of a change in the one or more parameters associated with the CAP scheme, and the second value of the field being indicative of the one or more parameters associated with the CAP scheme remaining the same, decode one or more additional fields of the set of multiple fields of the frame in accordance with the field including the first value, and communicate with the second AP according to one or more updated parameters associated with the CAP scheme.

Another first wireless AP for wireless communications is described. The first wireless AP may include means for communicating with a second AP according to a CAP scheme in accordance with one or more parameters associated with the CAP scheme, means for receiving a frame including a set of multiple fields, the set of multiple fields including a field including one of a first value or a second value, the first value of the field being indicative of a change in the one or more parameters associated with the CAP scheme, and the second value of the field being indicative of the one or more parameters associated with the CAP scheme remaining the same, means for decoding one or more additional fields of the set of multiple fields of the frame in accordance with the field including the first value, and means for communicating with the second AP according to one or more updated parameters associated with the CAP scheme.

A non-transitory computer-readable medium storing code for wireless communications is described. The code may include instructions executable by one or more processors to communicate with a second AP according to a CAP scheme in accordance with one or more parameters associated with the CAP scheme, receive a frame including a set of multiple fields, the set of multiple fields including a field including one of a first value or a second value, the first value of the field being indicative of a change in the one or more parameters associated with the CAP scheme, and the second value of the field being indicative of the one or more parameters associated with the CAP scheme remaining the same, decode one or more additional fields of the set of multiple fields of the frame in accordance with the field including the first value, and communicate with the second AP according to one or more updated parameters associated with the CAP scheme.

In some examples of the method, first wireless APs, and non-transitory computer-readable medium described herein, receiving the frame may include operations, features, means, or instructions for receiving the field including a CAP critical update flag (CAP-CUF) field.

In some examples of the method, first wireless APs, and non-transitory computer-readable medium described herein, receiving the field may include operations, features, means, or instructions for receiving the CAP-CUF field via a capabilities information and status indication field of the frame.

In some examples of the method, first wireless APs, and non-transitory computer-readable medium described herein, receiving the field may include operations, features, means, or instructions for receiving, in accordance with the CAP scheme, the CAP-CUF field associated with a first communication link of the first AP and a second communication link of the second AP, the first communication link having one or more first subchannels that at least partially overlap one or more second subchannels of the second communication link.

In some examples of the method, first wireless APs, and non-transitory computer-readable medium described herein, receiving the field may include operations, features, means, or instructions for receiving the CAP-CUF field, the CAP-CUF field being common across one or more communication links associated with the second AP, the one or more communication links associated with the CAP scheme, with one or more other CAP schemes, or both.

In some examples of the method, first wireless APs, and non-transitory computer-readable medium described herein, receiving the frame may include operations, features, means, or instructions for receiving the set of multiple fields including a CAP parameter change count (CAP-PCC) field, a value of the CAP-PCC field being greater than a previous value of the CAP-PCC field in accordance with the change in the one or more parameters.

In some examples of the method, first wireless APs, and non-transitory computer-readable medium described herein, receiving the set of multiple fields may include operations, features, means, or instructions for receiving the CAP-PCC field via an operations element of the frame or via a reduced neighbor report element of the frame.

In some examples of the method, first wireless APs, and non-transitory computer-readable medium described herein, receiving the set of multiple fields may include operations, features, means, or instructions for receiving the CAP-PCC field associated with a first communication link that overlaps at least partially with a second communication link associated with the second AP in accordance with the CAP scheme.

In some examples of the method, first wireless APs, and non-transitory computer-readable medium described herein, receiving the frame may include operations, features, means, or instructions for receiving the first field including one of the first value or the second value, the first value of the first field being indicative of the change in the one or more parameters associated with the CAP scheme, and the second value of the first field being indicative of the one or more parameters associated with the CAP scheme remaining the same and decoding the one or more additional fields of the set of multiple fields of the frame in accordance with the first field including the first value.

In some examples of the method, first wireless APs, and non-transitory computer-readable medium described herein, the frame includes a beacon frame, an extended beacon frame, a probe response frame, or a dedicated CAP advertisement frame.

In some examples of the method, first wireless APs, and non-transitory computer-readable medium described herein, the one or more parameters include parameters associated with one or more of a coordinated time division multiple access scheme, a coordinated spatial reuse scheme, a coordinated restricted target wake time scheme, or another CAP technique.

Some examples of the method, first wireless APs, and non-transitory computer-readable medium described herein may further include operations, features, means, or instructions for transmitting a second frame including a request for the one or more updated parameters.

A method for wireless communications by a first wireless AP is described. The method may include communicating with a second AP according to a CAP scheme in accordance with one or more parameters associated with the CAP scheme, generating a frame including a set of multiple fields, the set of multiple fields including a field including one of a first value or a second value, the first value of the field being indicative of a change in the one or more parameters associated with the CAP scheme, and a second value of the field being indicative of the one or more parameters associated with the CAP scheme remaining the same, transmitting the frame, the field including the first value in accordance with a change in the one or more parameters associated with the CAP scheme, and communicating with the second AP according to one or more updated parameters associated with the CAP scheme.

A first wireless AP for wireless communications is described. The first wireless AP may include a processing system that includes processor circuitry and memory circuitry that stores code. The processing system may be configured to cause the first wireless AP to communicate with a second AP according to a CAP scheme in accordance with one or more parameters associated with the CAP scheme, generate a frame including a set of multiple fields, the set of multiple fields including a field including one of a first value or a second value, the first value of the field being indicative of a change in the one or more parameters associated with the CAP scheme, and a second value of the field being indicative of the one or more parameters associated with the CAP scheme remaining the same, transmit the frame, the field including the first value in accordance with a change in the one or more parameters associated with the CAP scheme, and communicate with the second AP according to one or more updated parameters associated with the CAP scheme.

Another first wireless AP for wireless communications is described. The first wireless AP may include means for communicating with a second AP according to a CAP scheme in accordance with one or more parameters associated with the CAP scheme, means for generating a frame including a set of multiple fields, the set of multiple fields including a field including one of a first value or a second value, the first value of the field being indicative of a change in the one or more parameters associated with the CAP scheme, and a second value of the field being indicative of the one or more parameters associated with the CAP scheme remaining the same, means for transmitting the frame, the field including the first value in accordance with a change in the one or more parameters associated with the CAP scheme, and means for communicating with the second AP according to one or more updated parameters associated with the CAP scheme.

A non-transitory computer-readable medium storing code for wireless communications is described. The code may include instructions executable by one or more processors to communicate with a second AP according to a CAP scheme in accordance with one or more parameters associated with the CAP scheme, generate a frame including a set of multiple fields, the set of multiple fields including a field including one of a first value or a second value, the first value of the field being indicative of a change in the one or more parameters associated with the CAP scheme, and a second value of the field being indicative of the one or more parameters associated with the CAP scheme remaining the same, transmit the frame, the field including the first value in accordance with a change in the one or more parameters associated with the CAP scheme, and communicate with the second AP according to one or more updated parameters associated with the CAP scheme.

In some examples of the method, first wireless APs, and non-transitory computer-readable medium described herein, transmitting the frame may include operations, features, means, or instructions for transmitting the field including a CAP-CUF field.

In some examples of the method, first wireless APs, and non-transitory computer-readable medium described herein, transmitting the field may include operations, features, means, or instructions for transmitting the CAP-CUF field via a capabilities information and status indication field of the frame.

In some examples of the method, first wireless APs, and non-transitory computer-readable medium described herein, transmitting the field may include operations, features, means, or instructions for transmitting, in accordance with the CAP scheme, the CAP-CUF field associated with a first communication link of the first AP and a second communication link of the second AP, the first communication link having one or more first subchannels that at least partially overlap one or more second subchannels of the second communication link.

In some examples of the method, first wireless APs, and non-transitory computer-readable medium described herein, transmitting the field may include operations, features, means, or instructions for transmitting the CAP-CUF field, the CAP-CUF field being common across one or more communication links associated with the first AP, the one or more communication links associated with the CAP scheme, with one or more other CAP schemes, or both.

In some examples of the method, first wireless APs, and non-transitory computer-readable medium described herein, the set of multiple fields include a CAP-PCC field and the method, apparatuses, and non-transitory computer-readable medium may include further operations, features, means, or instructions for adjusting a value of the CAP parameter change count field in accordance with the change in the one or more parameters.

In some examples of the method, first wireless APs, and non-transitory computer-readable medium described herein, transmitting the frame may include operations, features, means, or instructions for transmitting the CAP-PCC field via an operations element of the frame.

In some examples of the method, first wireless APs, and non-transitory computer-readable medium described herein, transmitting frame may include operations, features, means, or instructions for transmitting the CAP-PCC field associated with a first communication link of the first AP and a second communication link of the second AP, the first communication link having one or more first subchannels that at least partially overlap one or more second subchannels of the second communication link.

In some examples of the method, first wireless APs, and non-transitory computer-readable medium described herein, generating the frame may include operations, features, means, or instructions for generating the first field including one of the first value or the second value, the first value of the first field being indicative of the change in the one or more parameters associated with the CAP scheme, and the second value of the first field being indicative of the one or more parameters associated with the CAP scheme remaining the same.

In some examples of the method, first wireless APs, and non-transitory computer-readable medium described herein, the frame includes a beacon frame, an extended beacon frame, a probe response frame, or a dedicated CAP advertisement frame.

In some examples of the method, first wireless APs, and non-transitory computer-readable medium described herein, the one or more parameters include parameters associated with one or more of a coordinated time division multiple access scheme, a coordinated spatial reuse scheme, a coordinated restricted target wake time scheme, or another CAP technique.

Some examples of the method, first wireless APs, and non-transitory computer-readable medium described herein may further include operations, features, means, or instructions for receiving a second frame including a request for the one or more updated parameters.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a hierarchical format of an example PPDU usable for communications between a wireless AP and one or more wireless STAs.

FIG. 3 shows an example of a signaling diagram that supports indicating critical updates for coordinated access point mechanisms.

FIGS. 4A and 4B shows an example of a frame structure that supports indicating critical updates for coordinated access point mechanisms.

FIG. 5 shows an example of a process flow that supports indicating critical updates for coordinated access point mechanisms.

FIG. 6 shows a block diagram of an example wireless communication device that supports indicating critical updates for coordinated access point mechanisms.

FIGS. 7 through 12 show flowcharts illustrating example processes performable by or at a first wireless access point (AP) that supports indicating critical updates for coordinated access point mechanisms.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, an access point (AP) may communicate with one or more other APs according to a coordinated AP (CAP) scheme (such as coordinated TDMA (C-TDMA), coordinated spatial reuse (C-SR), coordinated restricted target wake time (C-RTWT), and so on). The CAP schemes may be, for example, methods for participating APs to coordinate sharing of resources, such as parameters related to time resource sharing, frequency resource sharing, service period (SP) usage, and the like. The AP may transmit or receive one or more frames indicating changes in the CAP scheme. In some examples, however, the AP and the one or more other APs may transmit one or more additional frames that may not indicate changes in the CAP scheme. The AP and the one or more other APs may accordingly decode the one or more additional frames to determine if the one or more additional frames indicate changes in the CAP scheme, which may increase processing and power consumption at the APs.

Various aspects relate generally relate to a field in a frame that may indicate whether the frame includes updates related to a CAP scheme. Various aspects relate more specifically to a CAP parameter change count (CAP-PCC) field which a transmitting AP may increment to indicate an update to one or more CAP scheme parameters, or a CAP critical update flag (CAP-CUF) field that may indicate whether the frame comprises updates related to the CAP scheme (such as or whether a receiving AP may transmit a frame to a transmitting AP requesting the updates). In some aspects, the CAP-PCC field, the CAP-CUF field, or both may be communication link-specific or common across one or more communication links between the AP and one or more STAs using the CAP scheme. In some aspects, the frame may include (such as via the CAP-PCC field) an indication of an index associated with one or more APs for which the update applies.

Particular aspects of the subject matter described in this disclosure may be implemented to realize one or more of the following potential advantages. The techniques employed by the described communication devices may provide benefits and enhancements to the operation of the communication devices, including relatively reduced power consumption and processing. For example, operations performed by the described communication devices may decrease power consumption and processing by allowing APs to determine whether to parse a frame based on a CAP-CUF or CAP-PCC value. APs may therefore parse relatively fewer frames as compared to systems without a CAP-CUF framework. In some implementations, operations performed by the described communication devices also may support increased coordination between devices, among other benefits, by allowing APs to indicate parameter changes related to CAP schemes.

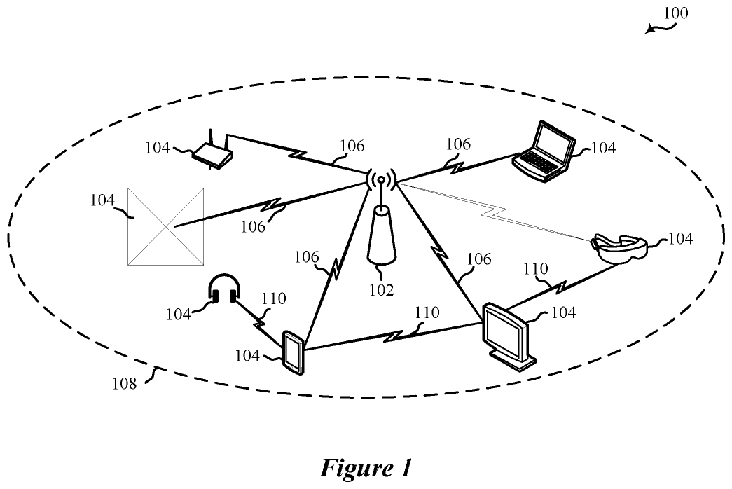

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

As described herein, an advertising AP 102 participating in a CAP scheme may transmit a frame to a receiving AP 102 to indicate whether the frame comprises updates related to the CAP scheme. For example, the frame may include a CAP-PCC field which the advertising AP 102 may increment to indicate an update and a CAP-CUF field that may indicate whether the frame comprises updates related to the CAP scheme (such as or whether the receiving AP 102 may transmit a frame to the advertising AP 102 requesting the updates). In some aspects, the CAP-PCC field, the CAP-CUF field, or both may be communication link-specific or common across one or more communication links between the advertising AP 102 and one or more STAs 104. In some aspects, the frame may include (such as via the CAP-PCC field) an indication of an index associated with one or more APs 102 in the CAP scheme for which the update applies.

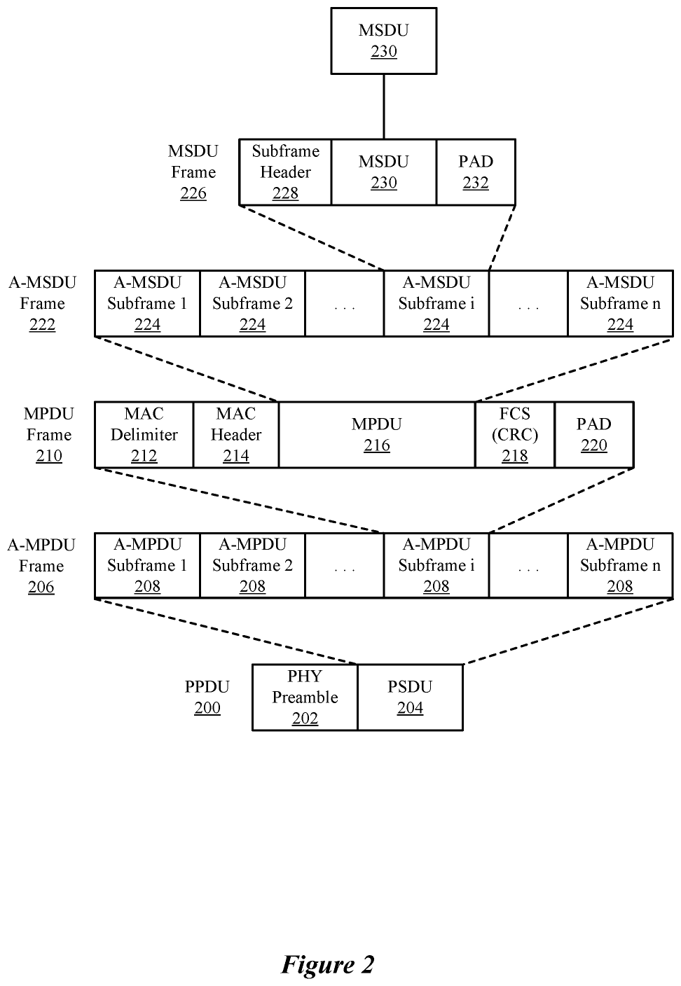

FIG. 2 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 200 includes a PHY preamble 202 and a PSDU 204. Each PSDU 204 may represent (or “carry”) one or more MAC protocol data units (MPDUs) 216. For example, each PSDU 204 may carry an aggregated MPDU (A-MPDU) 206 that includes an aggregation of multiple A-MPDU subframes 208. Each A-MPDU subframe 208 may include an MPDU frame 210 that includes a MAC delimiter 212 and a MAC header 214 prior to the accompanying MPDU 216, which includes the data portion (“payload” or “frame body”) of the MPDU frame 210. Each MPDU frame 210 also may include a frame check sequence (FCS) field 218 for error detection (such as the FCS field 218 may include a cyclic redundancy check (CRC)) and padding bits 220. The MPDU 216 may carry one or more MAC service data units (MSDUs) 230. For example, the MPDU 216 may carry an aggregated MSDU (A-MSDU) 222 including multiple A-MSDU subframes 224. Each A-MSDU subframe 224 may be associated with an MSDU frame 226 and may contain a corresponding MSDU 230 preceded by a subframe header 228 and, in some examples, followed by padding bits 232.

Referring back to the MPDU frame 210, the MAC delimiter 212 may serve as a marker of the start of the associated MPDU 216 and indicate the length of the associated MPDU 216. The MAC header 214 may include multiple fields containing information that defines or indicates characteristics or attributes of data encapsulated within the frame body. The MAC header 214 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 214 also includes one or more fields indicating addresses for the data encapsulated within the frame body. For example, the MAC header 214 may include a combination of a source address, a transmitter address, a receiver address or a destination address. The MAC header 214 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a CAP transmission session (such as a CAP scheme), during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a CAP TXOP indication (CTI) frame to other APs that indicates time and frequency of resources of the TXOP that can be shared. The sharing AP may select one or more candidate APs upon receiving a CAP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHZ, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the EHT-SIG field for an EHT PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (such as one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

As described herein, an advertising AP 102 participating in a CAP scheme may transmit a frame to a receiving AP 102 to indicate whether the frame comprises updates related to the CAP scheme. For example, the frame may include a CAP-PCC field which the advertising AP 102 may increment to indicate an update and a CAP-CUF field that may indicate whether the frame comprises updates related to the CAP scheme (such as whether the receiving AP 102 may parse the remainder of the frame or may transmit a frame to the advertising AP 102 requesting the updates). In some aspects, the CAP-PCC field, the CAP-CUF field, or both may be communication link-specific or common across one or more communication links between the advertising AP 102 and one or more STAs 104. In some aspects, the frame may include (such as via the CAP-PCC field) an indication of an index associated with one or more APs 102 in the CAP scheme for which the update applies or an index associated with the CAP scheme for which the update applies.

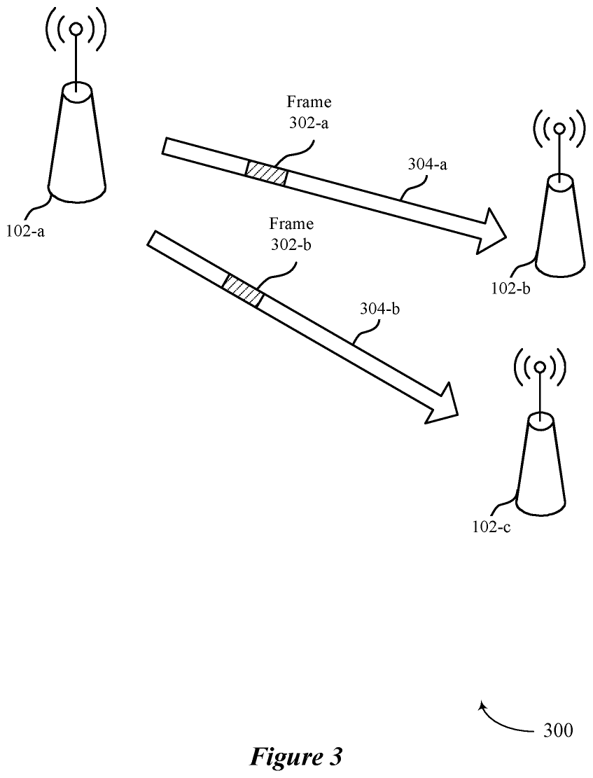

FIG. 3 shows an example of a signaling diagram 300 that supports indicating critical updates for coordinated access point mechanisms. The signaling diagram 300 may implement or may be implemented by aspects of the wireless communication network 100 or the PPDU 200. For example, the signaling diagram 300 may include one or more APs 102 (such as an AP 102-a, an AP 102-b, an AP 102-c), which may be examples of the corresponding devices as described with reference to FIG. 1.

In some wireless communication systems, an AP 102-a may operate according to CAP schemes, as described with reference to FIG. 2. For example, the AP 102-a may communicate with a STA 104 via first resources (such as a first communication link) that has one or more subchannels overlapping (at least partially) with one or more subchannels used by one or both of an AP 102-b and an AP 102-c to communicate with one or more additional STAs 104. The CAP techniques used by the AP 102-a may include C-TDMA techniques in which the AP 102-a coordinates resources with the AP 102-b or the AP 102-c in a time domain. Additionally, or alternatively, the CAP techniques may include C-SR techniques in which the AP 102-a coordinates resources with the AP 102-b or the AP 102-c in a spatial domain. Additionally, or alternatively, the CAP techniques may include C-RTWT techniques in which in which the AP 102-a coordinates resources with the AP 102-b or the AP 102-c regarding access to a wireless medium. The CAP techniques may additionally or alternatively include one or more techniques related to coordination between APs 102. To perform CAP techniques, the AP 102-a, the AP 102-b, or the AP 102-c may exchange information (such as parameters related to the CAP schemes) via frames 302 transmitted over communication links 304.

For example, the AP 102-a may transmit information related to the CAP schemes to the coordinating APs (such as the AP 102-b and the AP 102-c) by including relevant fields or information elements (IEs) in frames 302 (such as beacon frames, broadcast probe response frames, dedicated CAP advertisement frames, or extended beacon frames). However, in systems involving a relatively larger quantity of APs 102, power consumption and processing involved with receiving and decoding the frames 302 may be relatively larger than in systems involving a relatively smaller quantity of APs 102. For example, each AP 102 may receive and process frames 302 (such as beacon frames) transmitted by each coordinating AP 102, which may be a relatively larger quantity of frames 302 than in smaller systems. Such higher power consumption may reduce a battery life associated with devices in UHR systems. Additionally, some APs 102 may be referred to as soft APs that may have power constraints related to reduced wattage used to operate the soft APs. Such soft APs also may use relatively more power in multi-AP (MAP) or CAP communication as compared to non-MAP communication as a result of parsing frames 302 transmitted from each coordinating AP 102.

Some frames 302 (such as beacon or probe response frames) transmitted from APs 102 may include a critical update framework for the APs 102 to indicate to STAs 104 whether the frames 302 include updates relevant to the STAs 104 (such as modification of operations elements, parameters, or parameter sets; inclusion of one or more elements or parameters; BSS-wide updates; and so on). For example, the AP 102-a may include a critical update flag (CUF) with a value of 1 or an incremented check beacon field or parameter change count (PCC) field in a beacon frame or a traffic indication map (TIM) broadcast frame to indicate for an STA 104 to parse a frame. The STA 104 may skip parsing (such as decoding) the frame if the CUF field is not set to 1 or if the PCC or check beacon fields are not incremented.

However, the APs 102 may not reuse such techniques for indicating CAP-related updates. For example, if the AP 102-a transmits a frame 302 including a CUF with a value of 1 to indicate for the AP 102-b or the AP 102-c to parse the frame, an STA 104 also may receive the CUF with the value of 1 and also may parse the frame. Such techniques may therefore increase power consumption for non-AP STAs 104 (such as by parsing frames 302 when an update applies to an AP 102 rather than to the non-AP STAs 104).

Accordingly, techniques described herein may allow the AP 102-a to transmit (such as advertise) a frame 302-a via a link 304-a including one or more fields that indicate for the AP 102-b to parse the frame 302-a for one or more CAP-related updates. For example, the AP 102-a (such as and each AP 102 participating in coordination mechanisms with other APs 102) may maintain a CAP-CUF and a CAP-PCC. Each coordinating AP may maintain a record of the CAP-CUF and CAP-PCC of every other AP that it coordinates with.

The AP 102-a may include the CAP-PCC in each broadcast management frame (such as a beacon or beacon extension frame, a probe response frame, a dedicated CAP update frame) transmitted by the AP 102-a. The AP 102-a may increment a value of the CAP-PCC field (such as by 1), for example, when the AP 102-a updates (such as modifies) one or more parameters related to a CAP scheme. The one or more parameters may include, for example, C-TDMA parameters such as a processing delay associated with the AP 102-a between a schedule announcement frame and a TXOP allocation frame or updates to SCS agreements associated with CAP. Additionally, or alternatively, the one or more parameters may include C-SR parameters such as an interference that can be tolerated by the coordinating AP 102-a, criteria for determining inner or outer clients in SP-based C-SR (such as path loss or interference thresholds) or addition or removal of a downlink C-SR SP. Additionally, or alternatively, the one or more parameters may include C-RTWT parameters such as addition or removal or a R-TWT SP or modification of channel access parameters for an AP 102 to use within an SP (such as EDCA parameters for an AP 102 to use within an SP, how to end a TXOP before the C-RTWT SP, and so on). Additionally, or alternatively, the one or more parameters may include parameters corresponding to other CAP techniques such as coordinated beamforming, coordinated OFDMA, and the like.

In some examples, the AP 102-a may include the CAP-PCC in a UHR operations element or in a dedicated CAP operations element in the frame 302-a. In some examples, the AP 102-a may maintain a link-specific CAP-PCC (such as specific to a link over which AP 102-a may transmit the corresponding frame). That is, the AP 102-a may increment a link-specific CAP-PCC via an operations element in the frame 302-a to the AP 102-b when parameters related to a first communication link 304-a (such as between the AP 102-a and an STA 104) that includes first subchannels that at least partially overlap with second subchannels of a second communication link (such as between the AP 102-b and an STA 104) change. The AP 102-a may transmit a different link-specific CAP-PCC in a frame 302-b to the AP 102-c (such as via a link 304-b) including a CAP-PCC associated with parameters related to a third communication link 304-b (such as between the AP 102-a and an STA 104) including one or more subchannels that overlap with subchannels of a fourth communication link (such as between the AP 102-c and an STA 104) change. That is, if the AP 102-a is affiliated with an AP MLD, the AP 102-a may independently maintain (such as increment) a CAP-PCC associated with communication links of each affiliated AP.

In some examples, the AP 102-a may include each independently-maintained CAP-PCC in each frame 302 (such as each beacon frame, probe response frame, beacon extension frame, or dedicated CAP update frame). For example, each frame 302 may include a set of reduced neighbor report (RNR) elements which contain fields corresponding to each AP 102 associated with the AP MLD. Each RNR field may include the corresponding independently-maintained CAP-PCC.

The AP 102-a may include the CAP-CUF field in each broadcast management frame (such as a beacon or beacon extension frame, a probe response frame, a dedicated CAP advertisement frame) transmitted by the AP 102-a. The AP 102-a may include a value of 1 in the CAP-CUF field, for example, when the AP 102-a increments a CAP-PCC (such as until the AP 102-a transmits a next delivery traffic indication message (DTIM) beacon). When the AP 102-a transmits the next DTIM beacon, the AP 102-a may set the value of the CAP-CUF field to 0. The AP 102-a may include the CAP-CUF field in an early portion of the frame 302-a (such as in one or more fields or elements that are earlier in the frame than one or more other fields or elements) such that the AP 102-b or the AP 102-c may determine whether there is a CAP-specific update prior to parsing (or decoding) the frame 302. For example, the AP 102-a may include the CAP-CUF field in a reserved bit (such as B2, B3, B14, or B15) of a capabilities information and status indication field of the frame 302-a. Accordingly, the AP 102-b may parse the frame 302-a (such as a remainder of fields in the frame 302-a) if the CAP-CUF field is set to 1 and may skip parsing the frame 302-a (such as a remainder of fields in the frame 302-a) if the CAP-CUF field is set to 0.

In some examples, the CAP-CUF field may be link-specific. That is, the AP 102-a may set the CAP-CUF field in the frame 302-a to 1 in response to incrementing a CAP-PCC associated with the first link. In some examples, the CAP-CUF field may be common across one or more links (such as all links affiliated with the AP MLD). That is, the AP 102-a may set the CAP-CUF field in the frame 302-a to 1 in response to incrementing a CAP-PCC associated with the first link, with the third link, or any other link associated with the AP MLD (such as any CAP-PCC included in the one or more RNR fields of the frame 302-a and the frame 302-b).

In some examples, an AP pair (such as the AP 102-a and the AP 102-b or the AP 102-a and the AP 102-c) may participate in a subset of CAP schemes. As an illustrative example, the AP 102-a and the AP 102-b may participate in C-TDMA and C-RTWT and may not participate in C-SR. Similarly, the AP 102-a and the AP 102-c may participate in C-SR and C-RTWT and may not participate in C-TDMA. In such examples, the AP 102-a may increment a CAP-PCC and set the CAP-CUF to 1 when updating any CAP related parameters. Accordingly, the AP 102-b and the AP 102-c may parse frames 302 from the AP 102-a when the AP 102-a updates CAP parameters related to a CAP scheme that the AP 102-b or the AP 102-c do not participate in. For example, if the AP 102-a has an update related to C-SR (such as and not C-TDMA or C-RTWT), the AP 102-a may increment the CAP-PCC of the frame 302-a and set the CAP-CUF of the frame 302-a to 1. The AP 102-b may therefore parse the frame 302-a but may not use any C-SR related updates, which may increase power consumption at the AP 102-b. Similarly, if the AP 102-a has an update related to C-TDMA (such as and not C-SR or C-RTWT), the AP 102-a may increment the CAP-PCC of the frame 302-b and set the CAP-CUF of the frame 302-b to 1. The AP 102-c may therefore parse the frame 302-b but may not use any C-TDMA related updates, which may increase power consumption at the AP 102-c.

Accordingly, the AP 102-a may include a field or element in the frame 302 (such as a TIM element) to identify coordinating APs 102 for which an update may apply. In some examples, each AP 102 may have an AP identifier (APID) (such as a pairwise or global APID). Each AP 102 may derive a global APID associated with each other APs 102 using a pre-determined formula (such as APID=[1∥5 least significant bits (LSBs) of a corresponding AP 102∥ a BSS color of the AP 102). Additionally, or alternatively, each AP 102 may exchange pairwise APID information during an initial negotiation phase.

The AP 102-a may include an APID bitmap in each frame 302 (such as in the CAP-PCC field). The APID bitmap may include a bit corresponding to each APID (such as starting from a starting APID indicated via the CAP-PCC field). The AP 102-a may accordingly set a bit corresponding to an AP 102 to 1 if CAP related parameters that are related to a CAP scheme used by the corresponding AP 102 are updated. As an illustrative example, the AP 102-b may have an APID of 2050 and the AP 102-c may have an APID of 2051. If the AP 102-a updates one or more C-SR related parameters, the AP 102-a may transmit the frame 302-a with a bit in the bitmap corresponding to the APID of 2050 set to 0 and a bit in the bitmap corresponding to the APID of 2051 set to 1. Similarly, if the AP 102-a updates one or more C-TDMA related parameters, the AP 102-a may transmit the frame 302-a with a bit in the bitmap corresponding to the APID of 2050 set to 1 and a bit in the bitmap corresponding to the APID of 2051 set to 0. Accordingly, the AP 102-b (such as and the AP 102-c, respectively) may determine whether to parse the remainder of the frame 302 based on a value of the CAP-CUF field and based on a value of a bit corresponding to the APID of the AP 102-b (such as and a value of a bit corresponding to the APID of the AP 102-c, respectively). Such techniques may reduce power consumption at the AP 102-b and the AP 102-c by reducing a quantity of frames that the AP 102-b and the AP 102-c may parse.

In some examples, the AP 102-a may include a field or element in the frame 302 to identify one or more CAP schemes to which an update may apply. As an illustrative example, the AP 102-a may update one or more C-SR related parameters. As a result, the AP 102-a may transmit the frame 302-a with a bit (such as a bit in a CAP-CUF flag field) corresponding to a C-SR CAP scheme set to 1 or with an incremented CAP-PCC corresponding to a C-SR scheme. Similarly, if the AP 102-a updates one or more C-TDMA related parameters, the AP 102-a may transmit the frame 302-a with a bit (such as a bit in a CAP-CUF flag field) corresponding to a C-TDMA CAP scheme set to 1 or with an incremented CAP-PCC corresponding to a C-TDMA scheme. Accordingly, the AP 102-b (such as and the AP 102-c, respectively) may determine whether to parse the remainder of the frame 302 based on a value of the scheme-specific CAP-CUF field or the scheme-specific CAP-PCC and whether the AP 102-b (such as and the AP 102-c, respectively) is coordinating with AP 102-a using the respective CAP scheme (a respective CAP scheme corresponding to the respective scheme-specific CAP-CUF or CSP-PCC). Such techniques may reduce power consumption at the AP 102-b and the AP 102-c by reducing a quantity of frames that the AP 102-b and the AP 102-c may parse.

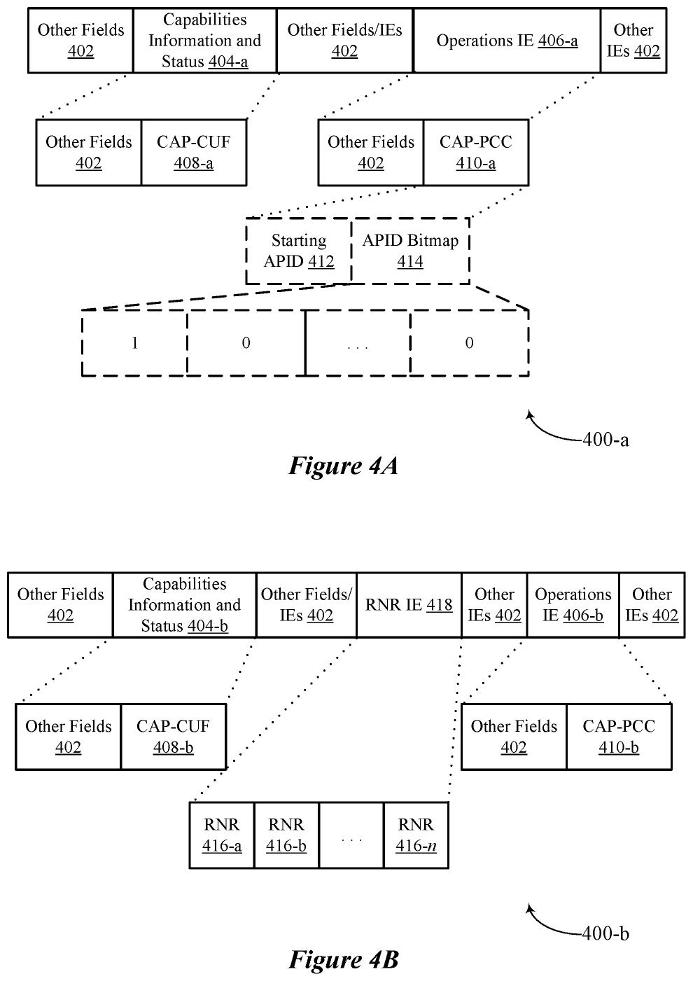

FIGS. 4A and 4B show examples of a frame structure 400-a and a frame structure 400-b that support indicating critical updates for coordinated access point mechanisms. The frame structures 400 may implement or may be implemented by aspects of the wireless communication network 100, the PPDU 200, or the signaling diagram 300. For example, the frame structures 400 may be implemented by one or more APs 102, which may be examples of the corresponding devices as described with reference to FIG. 1.

In some examples, as described with reference to FIG. 3, a first AP 102 may transmit a frame including one or more fields (such as a CAP-CUF field 408, a CAP-PCC field 410, one or more RNR fields 416, an APID bitmap 414) indicating whether one or more parameters associated with a CAP scheme have changed. As illustrated with reference to the frame structure 400-a, the frame may include one or more other fields or IEs 402 (such as one or more other fields 402 indicating one or more CAP scheme parameters). The frame may include a capabilities information and status indication field 404-a. The capabilities indication and status indication field may include a CAP-CUF field 408-a, which may include a first value (such as 1) if the one or more CAP scheme parameters have changed and a second value (such as 0) if the one or more CAP scheme parameters have not changed. The capabilities information and status indication field 404-a may include one or more other fields 402.

The frame may include an operations IE 406-a (such as a UHR operations element or a dedicated CAP operations element). The operations IE 406-a may include a CAP-PCC field 410-a. In some examples, a value of the CAP-PCC field 410-a may indicate a quantity of parameter updates associated with the CAP scheme. That is, the first AP 102 may increment the value of the CAP-PCC field 410-a if the AP 102 updates one or more parameters associated with the CAP scheme. The value of the CAP-CUF field 408-a may be set to the first value (such as 1) when the AP 102 increments the value of the CAP-PCC field 410-a. The operations IE 406-a may include one or more other fields 402.

In some examples, the CAP-PCC field 410-a may include one or more additional fields. For example, the CAP-PCC field 410-a may include a bitmap of APIDs. The APID bitmap 414 may include one or more fields each corresponding to an APID. Each APID may be an ID of an AP 102 coordinating with the first AP 102 using a CAP scheme. For example, the CAP-PCC field 410-a may include a starting APID field 412 indicating a first APID associated with a first field of the APID bitmap 414.

As an illustrative example, the starting APID field 412 may indicate a starting APID of 2050. The first AP 102 may set a value of the first field to 1 if a parameter associated with a CAP scheme used by an AP 102 with the APID 2050 changes. The first AP 102 may set one or more other fields of the APID bitmap 414 to 0 if parameters associated with CAP schemes used by one or more additional APs 102 (such as with APIDs following the first APID, such as 2051, 2052, and so on) have not changed.

In some examples, as illustrated with reference to the frame structure 400-b, the first AP may be affiliated with an AP MLD (such as an AP MLD associated with n communication links). In such examples, the frame may include one or more other fields or IEs 402 (such as one or more other fields 402 indicating one or more CAP scheme parameters). The frame may include a capabilities information and status indication field 404-b. The capabilities information and status indication field may include a CAP-CUF field 408-b, which may include a first value (such as 1) if the one or more CAP scheme parameters have changed and a second value (such as 0) if the one or more CAP scheme parameters have not changed. The capabilities information and status indication field 404-a may include one or more other fields 402.

In some examples, the CAP-CUF field 408-b may be link-specific. That is, the CAP-CUF field 408-b may include a value of 1 if the one or more CAP scheme parameters are associated with a first communication link between the first AP and an STA 104 if the first communication link overlaps at least partially (such as that includes at least one overlapping subchannel) with a second communication link between an AP 102 that receives the frame and an STA 104. In such examples, the CAP-CUF field 408-b may include a value of 1 if the first AP 102 increments a CAP-PCC field 410-b. In some examples, the CAP-CUF field 408-b may be link-common. That is, the CAP-CUF field 408-b may include a value of 1 if the one or more CAP scheme parameters are associated with the first link or one or more other links associated with the AP MLD (such as links indicated via one or more RNR fields 416). In such examples, the CAP-CUF field 408-b may include a value of 1 if the first AP 102 increments a PCC indicated by one or more RNR fields 416.

The frame may include an operations IE 406-b (such as a UHR operations element or a dedicated CAP operations element). The operations IE 406-b may include a CAP-PCC field 410-b (such as a link-specific field associated with the first link). In some examples, a value of the CAP-PCC field 410-a may indicate a quantity of parameter updates associated with the CAP scheme. That is, the first AP 102 may increment the value of the CAP-PCC field 410-a if the AP 102 updates one or more parameters associated with the CAP scheme (such as a CAP scheme associated with the first link). The value of the CAP-CUF field 408-b may be set to the first value (such as 1) when the AP 102 increments the value of the CAP-PCC field 410-b. The operations IE 406-b may include one or more other fields 402.

In some examples, the frame structure 400-b may include an RNR IE 418. The RNR IE 418 may include an RNR field 416 associated with each link of the AP MLD (such as an RNR field 416-a, an RNR field 416-b, and so on through an RNR field 416-n). In some examples, each RNR field 416 may include a PCC field associated with each respective link of the AP MLD. That is, the first AP 102 may increment the value of the PCC field of a given RNR field 416 if the AP 102 updates one or more parameters associated with link of the RNR field 416. The value of the CAP-CUF field 408-b may be set to the first value (such as 1) when the AP 102 increments the value of any PCC field of the RNR fields 416 (such as if the CAP-CUF field 408-b is link-common).

In some examples, the first AP 102 may transmit some combination of the frame structure 400-a and the frame structure 400-b. For example, the AP 102 may transmit a frame including both of an RNR IE 418 and an APID bitmap 414.

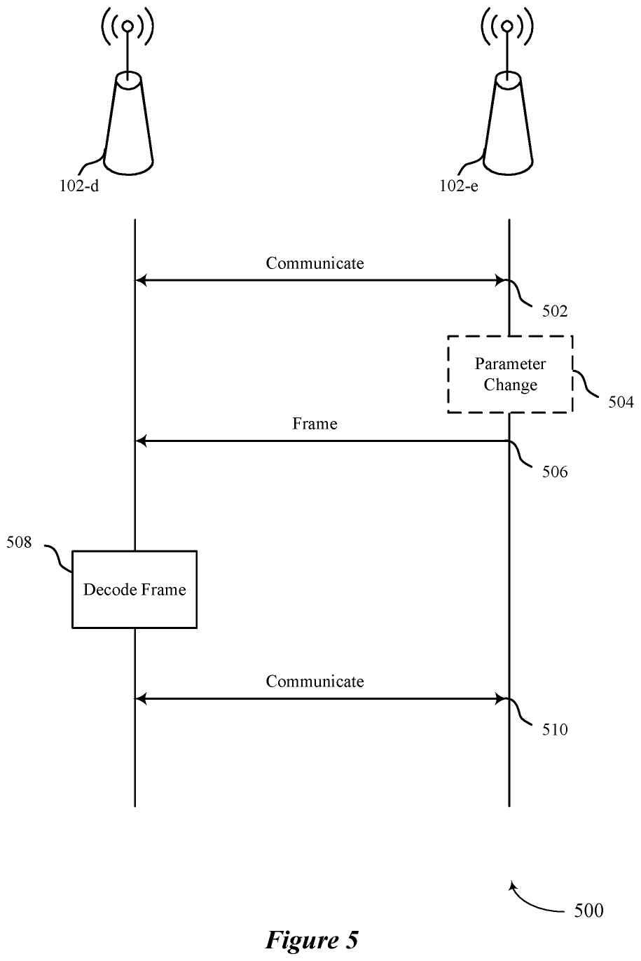

FIG. 5 shows an example of a process flow 500 that supports indicating critical updates for coordinated access point mechanisms. The process flow 500 may implement or may be implemented by aspects of the wireless communication network 100, the PPDU 200, the signaling diagram 300, or the frame structures 400. For example, the process flow 500 may be implemented by one or more APs 102 (such as an AP 102-d, an AP 102-e), which may be examples of the corresponding devices as described with reference to FIG. 1. In some examples, the AP 102-d and the AP 102-e (such as and one or more additional APs 102) may operate according to CAP schemes, as described with reference to FIG. 2. The CAP schemes may include a C-TDMA scheme, a C-SR scheme, a C-RTWT scheme, or one or more other CAP schemes.

In the following description of the process flow 500, the operations between the AP 102-d and the AP 102-e may occur in a different order than the example order shown and in some examples may be performed by one or more different devices other than those shown as examples. Some operations also may be omitted from the process flow 500, and other operations may be added to the process flow 500. Further, although some operations or signaling may be shown to occur at different times for discussion purposes, these operations may actually occur at the same time.

At 502, the AP 102-d and the AP 102-e may communicate according to a CAP scheme (such as a C-TDMA scheme, a C-SR scheme, a C-RTWT scheme, or one or more other CAP schemes). The CAP scheme may be associated with one or more parameters. For example, the CAP scheme may be associated with C-TDMA parameters, C-SR parameters, or C-RTWT parameters. In some examples, the AP 102-e may communicate with an STA 104 via a first communication link, and the AP 102-d may communicate with an STA 104 via a second communication link that overlaps at least partially with the first communication link (such as with at least one overlapping subchannel). In some examples, one or more additional APs 102 may communicate with STAs 104 via additional communication links (such as communication links that do not overlap with the second communication link).

In some examples, at 504, the AP 102-e may identify a change in the one or more parameters associated with the CAP scheme. The AP 102-e may generate a frame (such as a beacon frame, a beacon extension frame, a probe response frame, a dedicated CAP advertisement frame) including one or more fields in response to identifying the change. The frame may include, for example, a field (such as a CAP-CUF field) to indicate whether the one or more parameters have changed. For example, the CAP-CUF field may include a first value (such as 1) if AP 102-e identifies that the one or more parameters have changed, or a second value (such as 0) if the AP 102-e does not identify that the one or more parameters have changed (such as if the parameters remain the same). The CAP-CUF field may be in a capabilities information and status indication field of the frame. The CAP-CUF field may be specific to the first communications link, or may be common across the first communication link and the one or more additional communication links.

In some examples, the AP 102-e may generate the frame including a CAP-PCC field. The AP 102-e may adjust (such as increment) a value of the CAP-PCC field in response to identifying the change in the one or more parameters. The CAP-PCC field may be in an operations element (such as a UHR operations element or a dedicated CAP operations element) of the frame. The CAP-PCC field may be specific to the first communication link. That is, the CAP-PCC field may indicate a quantity of parameter updates associated with the communications link

Additionally, or alternatively, the CAP-PCC field may be in an RNR field of the frame. For example, the frame may include one or more RNR fields associated with the communication links, and each RNR field may include a corresponding CAP-PCC field for each of the communication links. In such examples, each CAP-PCC field may indicate a quantity of parameter updates associated with each corresponding communication link.

Additionally, or alternatively, the CAP-PCC field may be technique- or CAP scheme-specific. That is, in some examples, the frame may include a first CAP-PCC field associated with a C-SR CAP scheme, a second CAP-PCC field associated with a C-TDMA scheme, a third CAP-PCC field associated with a C-RTWT scheme, and so on. The AP 102-e may accordingly adjust (such as increment) a value of each CAP-PCC field corresponding to a CAP scheme for which one or more parameters change.

In some examples, the AP 102-e may generate the frame including a set of fields (such as a bitmap) each associated with a respective APID of the AP 102-d (such as and the one or more additional APs 102). That is, a first field of the set of fields may be associated with the APID of the AP 102-d. The AP 102-e may generate the first field including the first value (such as 1) if AP 102-e identifies that the one or more parameters have changed, or the second value (such as 0) if the AP 102-e does not identify that the one or more parameters have changed (such as if the parameters remain the same).

At 506, the AP 102-e may transmit the frame including the plurality of fields to the AP 102-d (such as via the communication link). The CAP-CUF field (such as and the first field of the set of fields) may include the first value. The CAP-PCC field may include the adjusted (such as incremented) value. The AP 102-d may receive the frame and determine that the CAP-CUF field includes the first value (such as 1), and thus that the one or more parameters have changed. Additionally, or alternatively, the AP 102-d compare the value of the received CAP-PCC field with a previously recorded value of CAP-PCC associated with AP 102-e and may transmit a request (such as via a frame) to the AP 102-e for the AP 102-d to retrieve the one or more new parameter values in accordance with the received CAP-PCC value being different from the previous recorded value of CAP-PCC.

At 508, the AP 102-d may decode (e.g., parse) one or more additional fields of the frame based on receiving the CAP-CUF field including the first value. For example, the AP 102-d may decode (e.g., parse) the remainder of the frame (such as to determine one or more new parameter values for the one or more parameters associated with the CAP scheme). In some examples, the AP 102-d may decode (e.g., parse) the set of fields (such as the first field), and may determine that the one or more parameters have changed based on the first field including the first value. That is, the AP 102-d may parse the remainder of the frame based on both of the CAP-CUF field and the first field of the set of fields (such as associated with the APID of the AP 102-d) including the first value (such as 1). Additionally, or alternatively, the AP 102-d may transmit a request (such as via a frame) to the AP 102-e for the AP 102-d to retrieve the one or more new parameter values.

At 510, the AP 102-d and the AP 102-e may communicate according to the CAP scheme (such as using the updated parameters associated with the CAP scheme). For example, the AP 102-d and the AP 102-e may perform CAP communications (such as with one or more STAs 104) in accordance with an updated CAP scheme (such as updated according to the updated parameters).

[Inventors: Please describe any other ways that your invention can be built, performed or used differently from the way disclosed]

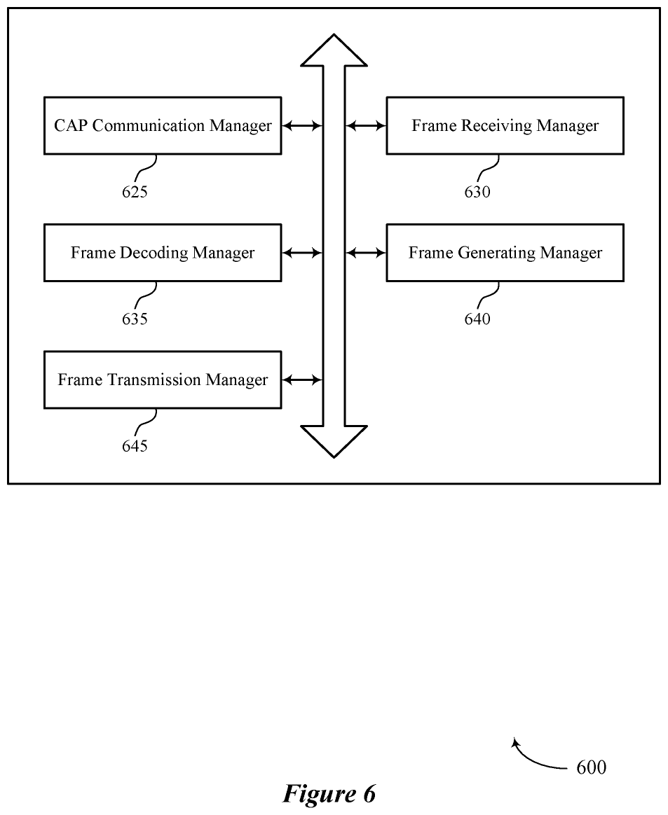

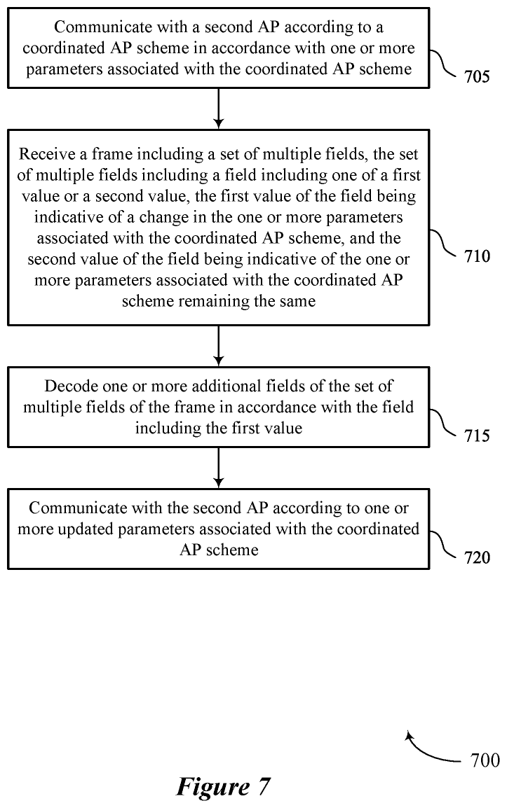

FIG. 6 shows a block diagram of an example wireless communication device 600 that supports indicating critical updates for coordinated access point mechanisms. In some examples, the wireless communication device 600 is configured to perform the processes 700, 800, 900, 1000, 1100, and 1200 described with reference to FIGS. 7, 8, 9, 10, 11, and 12, respectively. The wireless communication device 600 may include one or more chips, SoCs, chipsets, packages, components or devices that individually or collectively constitute or include a processing system. The processing system may interface with other components of the wireless communication device 600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 600 may transmit the information output from the chip. In such an example, the second interface may refer to an interface between the processing system of the chip and a reception component, such that the wireless communication device 600 may receive information that is then passed to the processing system. In some such examples, the first interface also may obtain information, such as from the transmission component, and the second interface also may output information, such as to the reception component.

The processing system of the wireless communication device 600 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 600 can be configurable or configured for use in an AP, such as the AP 102 described with reference to FIG. 1. In some other examples, the wireless communication device 600 can be an AP that includes such a processing system and other components including multiple antennas. The wireless communication device 600 is capable of transmitting and receiving wireless communications in the form of, for example, wireless packets. For example, the wireless communication device 600 can be configurable or configured to transmit and receive packets in the form of physical layer PPDUs and MPDUs conforming to one or more of the IEEE 802.11 family of wireless communication protocol standards. In some other examples, the wireless communication device 600 can be configurable or configured to transmit and receive signals and communications conforming to one or more 3GPP specifications including those for 5G NR or 6G. In some examples, the wireless communication device 600 also includes or can be coupled with one or more application processors which may be further coupled with one or more other memories. In some examples, the wireless communication device 600 further includes at least one external network interface coupled with the processing system that enables communication with a core network or backhaul network that enables the wireless communication device 600 to gain access to external networks including the Internet.

The wireless communication device 600 includes a CAP communication manager 625, a frame receiving manager 630, a frame decoding manager 635, a frame generating manager 640, and a frame transmission manager 645. Portions of one or more of the CAP communication manager 625, the frame receiving manager 630, the frame decoding manager 635, the frame generating manager 640, and the frame transmission manager 645 may be implemented at least in part in hardware or firmware. For example, one or more of the CAP communication manager 625, the frame receiving manager 630, the frame decoding manager 635, the frame generating manager 640, and the frame transmission manager 645 may be implemented at least in part by at least a processor or a modem. In some examples, portions of one or more of the CAP communication manager 625, the frame receiving manager 630, the frame decoding manager 635, the frame generating manager 640, and the frame transmission manager 645 may be implemented at least in part by a processor and software in the form of processor-executable code stored in memory.

The wireless communication device 600 may support wireless communications in accordance with examples as disclosed herein. The CAP communication manager 625 is configurable or configured to communicate with a second AP according to a coordinated AP scheme in accordance with one or more parameters associated with the coordinated AP scheme. The frame receiving manager 630 is configurable or configured to receive a frame including a set of multiple fields, the set of multiple fields including a field including one of a first value or a second value, the first value of the field being indicative of a change in the one or more parameters associated with the coordinated AP scheme, and the second value of the field being indicative of the one or more parameters associated with the coordinated AP scheme remaining the same. The frame decoding manager 635 is configurable or configured to decode one or more additional fields of the set of multiple fields of the frame in accordance with the field including the first value. In some examples, the CAP communication manager 625 is configurable or configured to communicate with the second AP according to one or more updated parameters associated with the coordinated AP scheme.

In some examples, to support receiving the frame, the frame receiving manager 630 is configurable or configured to receive the field including a coordinated AP critical update flag field.

In some examples, to support receiving the field, the frame receiving manager 630 is configurable or configured to receive the coordinated AP critical update flag field via a capabilities information and status indication field of the frame.

In some examples, to support receiving the field, the frame receiving manager 630 is configurable or configured to receive, in accordance with the coordinated AP scheme, the coordinated AP critical update flag field associated with a first communication link of the first AP and a second communication link of the second AP, the first communication link having one or more first subchannels that at least partially overlap one or more second subchannels of the second communication link.

In some examples, to support receiving the field, the frame receiving manager 630 is configurable or configured to receive the coordinated AP critical update flag field, the coordinated AP critical update flag field being common across one or more communication links associated with the second AP, the one or more communication links associated with the coordinated AP scheme, with one or more other coordinated AP schemes, or both.

In some examples, to support receiving the frame, the frame receiving manager 630 is configurable or configured to receive the set of multiple fields including a coordinated AP parameters change count field, a value of the coordinated AP parameters change count field being greater than a previous value of the coordinated AP parameters change count field in accordance with the change in the one or more parameters.

In some examples, to support receiving the set of multiple fields, the frame receiving manager 630 is configurable or configured to receive the coordinated AP parameters change count field via an operations element of the frame or via a reduced neighbor report element of the frame.

In some examples, to support receiving the set of multiple fields, the frame receiving manager 630 is configurable or configured to receive the coordinated AP parameters change count field associated with a first communication link that overlaps at least partially with a second communication link associated with the second AP in accordance with the coordinated AP scheme.

In some examples, to support receiving the frame, the frame receiving manager 630 is configurable or configured to receive the first field including one of the first value or the second value, the first value of the first field being indicative of the change in the one or more parameters associated with the coordinated AP scheme, and the second value of the first field being indicative of the one or more parameters associated with the coordinated AP scheme remaining the same. In some examples, to support receiving the frame, the frame decoding manager 635 is configurable or configured to decode the one or more additional fields of the set of multiple fields of the frame in accordance with the first field including the first value.

In some examples, the frame includes a beacon frame, an extended beacon frame, a probe response frame, or a dedicated coordinated AP advertisement frame.

In some examples, the one or more parameters include parameters associated with one or more of a coordinated time division multiple access scheme, a coordinated spatial reuse scheme, a coordinated restricted target wake time scheme, or another coordinated AP technique.

In some examples, the frame transmission manager 645 is configurable or configured to transmit a second frame including a request for the one or more updated parameters.

Additionally, or alternatively, the wireless communication device 600 may support wireless communications in accordance with examples as disclosed herein. In some examples, the CAP communication manager 625 is configurable or configured to communicate with a second AP according to a coordinated AP scheme in accordance with one or more parameters associated with the coordinated AP scheme. The frame generating manager 640 is configurable or configured to generate a frame including a set of multiple fields, the set of multiple fields including a field including one of a first value or a second value, the first value of the field being indicative of a change in the one or more parameters associated with the coordinated AP scheme, and a second value of the field being indicative of the one or more parameters associated with the coordinated AP scheme remaining the same. The frame transmission manager 645 is configurable or configured to transmit the frame, the field including the first value in accordance with a change in the one or more parameters associated with the coordinated AP scheme. In some examples, the CAP communication manager 625 is configurable or configured to communicate with the second AP according to one or more updated parameters associated with the coordinated AP scheme.

In some examples, to support transmitting the frame, the frame transmission manager 645 is configurable or configured to transmit the field including a coordinated AP critical update flag field.

In some examples, to support transmitting the field, the frame transmission manager 645 is configurable or configured to transmit the coordinated AP critical update flag field via a capabilities information and status indication field of the frame.

In some examples, to support transmitting the field, the frame transmission manager 645 is configurable or configured to transmit, in accordance with the coordinated AP scheme, the coordinated AP critical update flag field associated with a first communication link of the first AP and a second communication link of the second AP, the first communication link having one or more first subchannels that at least partially overlap one or more second subchannels of the second communication link.

In some examples, to support transmitting the field, the frame transmission manager 645 is configurable or configured to transmit the coordinated AP critical update flag field, the coordinated AP critical update flag field being common across one or more communication links associated with the first AP, the one or more communication links associated with the coordinated AP scheme, with one or more other coordinated AP schemes, or both.

In some examples, the set of multiple fields include a coordinated AP parameters change count field, and the frame generating manager 640 is configurable or configured to adjust a value of the coordinated AP parameter change count field in accordance with the change in the one or more parameters.

In some examples, to support transmitting the frame, the frame transmission manager 645 is configurable or configured to transmit the coordinated AP parameters change count field via an operations element of the frame.

In some examples, to support transmitting frame, the frame transmission manager 645 is configurable or configured to transmit the coordinated AP parameters change count field associated with a first communication link of the first AP and a second communication link of the second AP, the first communication link having one or more first subchannels that at least partially overlap one or more second subchannels of the second communication link.

In some examples, to support generating the frame, the frame generating manager 640 is configurable or configured to generate the first field including one of the first value or the second value, the first value of the first field being indicative of the change in the one or more parameters associated with the coordinated AP scheme, and the second value of the first field being indicative of the one or more parameters associated with the coordinated AP scheme remaining the same.

In some examples, the frame includes a beacon frame, an extended beacon frame, a probe response frame, or a dedicated coordinated AP advertisement frame.

In some examples, the one or more parameters include parameters associated with one or more of a coordinated time division multiple access scheme, a coordinated spatial reuse scheme, a coordinated restricted target wake time scheme, or another coordinated AP technique.

In some examples, the frame receiving manager 630 is configurable or configured to receive a second frame including a request for the one or more updated parameters.

FIG. 7 shows a flowchart illustrating an example process 700 performable by or at a first wireless AP that supports indicating critical updates for coordinated access point mechanisms. The operations of the process 700 may be implemented by a first wireless AP or its components as described herein. For example, the process 700 may be performed by a wireless communication device, such as the wireless communication device 600 described with reference to FIG. 6, operating as or within a wireless AP. In some examples, the process 700 may be performed by a wireless AP, such as one of the APs 102 described with reference to FIG. 1.

In some examples, in 705, the first wireless AP may communicate with a second AP according to a coordinated AP scheme in accordance with one or more parameters associated with the coordinated AP scheme. The operations of 705 may be performed in accordance with examples as disclosed herein. In some implementations, aspects of the operations of 705 may be performed by a CAP communication manager 625 as described with reference to FIG. 6.

In some examples, in 710, the first wireless AP may receive a frame including a set of multiple fields, the set of multiple fields including a field including one of a first value or a second value, the first value of the field being indicative of a change in the one or more parameters associated with the coordinated AP scheme, and the second value of the field being indicative of the one or more parameters associated with the coordinated AP scheme remaining the same. The operations of 710 may be performed in accordance with examples as disclosed herein. In some implementations, aspects of the operations of 710 may be performed by a frame receiving manager 630 as described with reference to FIG. 6.

In some examples, in 715, the first wireless AP may decode one or more additional fields of the set of multiple fields of the frame in accordance with the field including the first value. The operations of 715 may be performed in accordance with examples as disclosed herein. In some implementations, aspects of the operations of 715 may be performed by a frame decoding manager 635 as described with reference to FIG. 6.

In some examples, in 720, the first wireless AP may communicate with the second AP according to one or more updated parameters associated with the coordinated AP scheme. The operations of 720 may be performed in accordance with examples as disclosed herein. In some implementations, aspects of the operations of 720 may be performed by a CAP communication manager 625 as described with reference to FIG. 6.

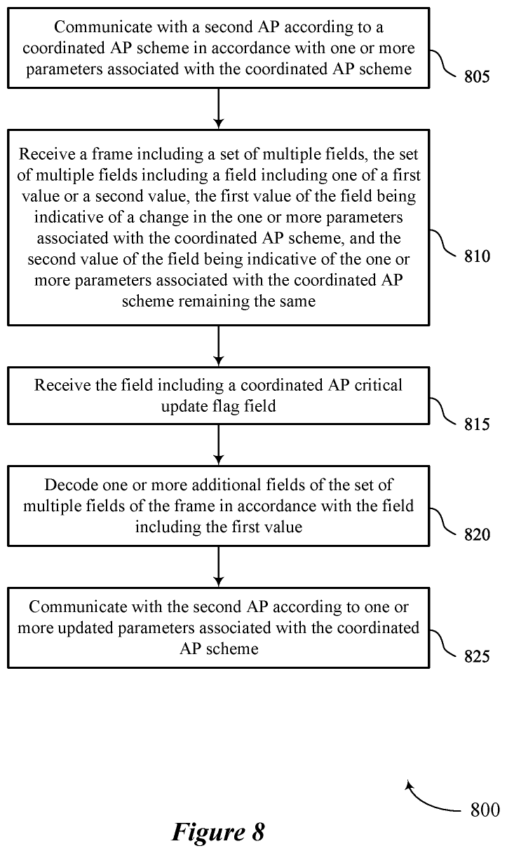

FIG. 8 shows a flowchart illustrating an example process 800 performable by or at a first wireless AP that supports indicating critical updates for coordinated access point mechanisms. The operations of the process 800 may be implemented by a first wireless AP or its components as described herein. For example, the process 800 may be performed by a wireless communication device, such as the wireless communication device 600 described with reference to FIG. 6, operating as or within a wireless AP. In some examples, the process 800 may be performed by a wireless AP, such as one of the APs 102 described with reference to FIG. 1.

In some examples, in 805, the first wireless AP may communicate with a second AP according to a coordinated AP scheme in accordance with one or more parameters associated with the coordinated AP scheme. The operations of 805 may be performed in accordance with examples as disclosed herein. In some implementations, aspects of the operations of 805 may be performed by a CAP communication manager 625 as described with reference to FIG. 6.

In some examples, in 810, the first wireless AP may receive a frame including a set of multiple fields, the set of multiple fields including a field including one of a first value or a second value, the first value of the field being indicative of a change in the one or more parameters associated with the coordinated AP scheme, and the second value of the field being indicative of the one or more parameters associated with the coordinated AP scheme remaining the same. The operations of 810 may be performed in accordance with examples as disclosed herein. In some implementations, aspects of the operations of 810 may be performed by a frame receiving manager 630 as described with reference to FIG. 6.

In some examples, in 815, the first wireless AP may receive the field including a coordinated AP critical update flag field. The operations of 815 may be performed in accordance with examples as disclosed herein. In some implementations, aspects of the operations of 815 may be performed by a frame receiving manager 630 as described with reference to FIG. 6.

In some examples, in 820, the first wireless AP may decode one or more additional fields of the set of multiple fields of the frame in accordance with the field including the first value. The operations of 820 may be performed in accordance with examples as disclosed herein. In some implementations, aspects of the operations of 820 may be performed by a frame decoding manager 635 as described with reference to FIG. 6.

In some examples, in 825, the first wireless AP may communicate with the second AP according to one or more updated parameters associated with the coordinated AP scheme. The operations of 825 may be performed in accordance with examples as disclosed herein. In some implementations, aspects of the operations of 825 may be performed by a CAP communication manager 625 as described with reference to FIG. 6.

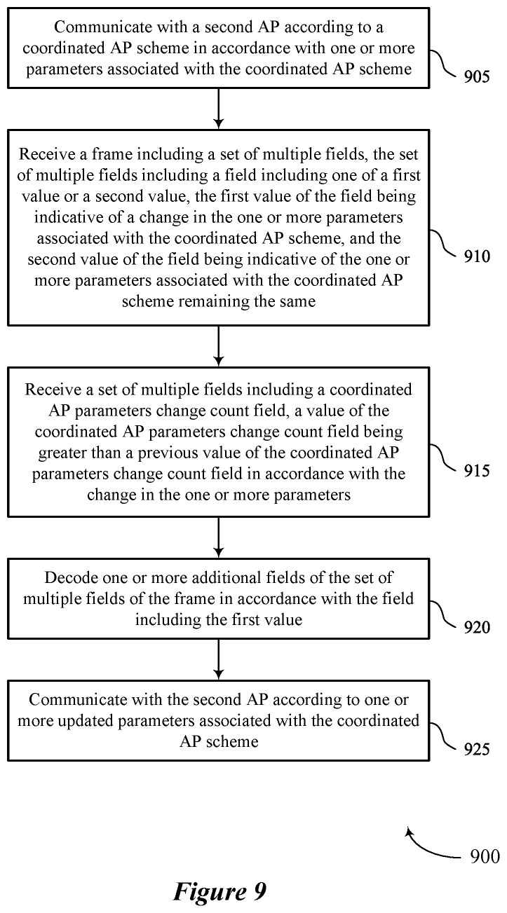

FIG. 9 shows a flowchart illustrating an example process 900 performable by or at a first wireless AP that supports indicating critical updates for coordinated access point mechanisms. The operations of the process 900 may be implemented by a first wireless AP or its components as described herein. For example, the process 900 may be performed by a wireless communication device, such as the wireless communication device 600 described with reference to FIG. 6, operating as or within a wireless AP. In some examples, the process 900 may be performed by a wireless AP, such as one of the APs 102 described with reference to FIG. 1.

In some examples, in 905, the first wireless AP may communicate with a second AP according to a coordinated AP scheme in accordance with one or more parameters associated with the coordinated AP scheme. The operations of 905 may be performed in accordance with examples as disclosed herein. In some implementations, aspects of the operations of 905 may be performed by a CAP communication manager 625 as described with reference to FIG. 6.

In some examples, in 910, the first wireless AP may receive a frame including a set of multiple fields, the set of multiple fields including a field including one of a first value or a second value, the first value of the field being indicative of a change in the one or more parameters associated with the coordinated AP scheme, and the second value of the field being indicative of the one or more parameters associated with the coordinated AP scheme remaining the same. The operations of 910 may be performed in accordance with examples as disclosed herein. In some implementations, aspects of the operations of 910 may be performed by a frame receiving manager 630 as described with reference to FIG. 6.

In some examples, in 915, the first wireless AP may receive a set of multiple fields including a coordinated AP parameters change count field, a value of the coordinated AP parameters change count field being greater than a previous value of the coordinated AP parameters change count field in accordance with the change in the one or more parameters. The operations of 915 may be performed in accordance with examples as disclosed herein. In some implementations, aspects of the operations of 915 may be performed by a frame receiving manager 630 as described with reference to FIG. 6.

In some examples, in 920, the first wireless AP may decode one or more additional fields of the set of multiple fields of the frame in accordance with the field including the first value. The operations of 920 may be performed in accordance with examples as disclosed herein. In some implementations, aspects of the operations of 920 may be performed by a frame decoding manager 635 as described with reference to FIG. 6.

In some examples, in 925, the first wireless AP may communicate with the second AP according to one or more updated parameters associated with the coordinated AP scheme. The operations of 925 may be performed in accordance with examples as disclosed herein. In some implementations, aspects of the operations of 925 may be performed by a CAP communication manager 625 as described with reference to FIG. 6.

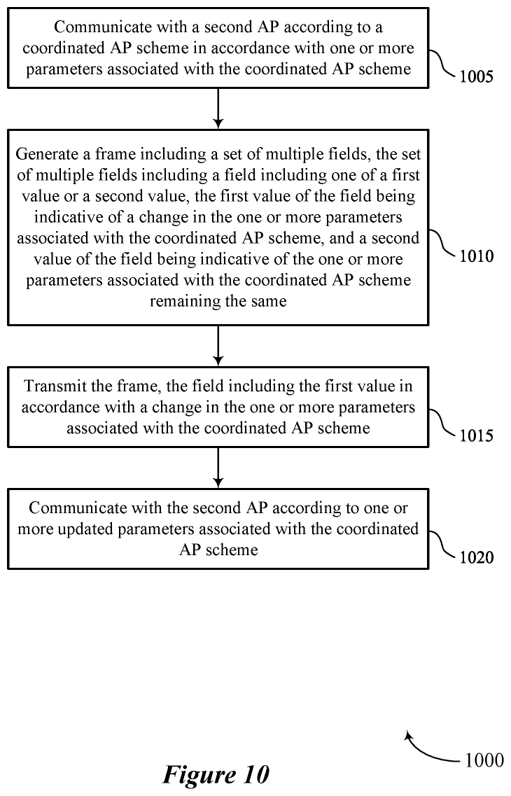

FIG. 10 shows a flowchart illustrating an example process 1000 performable by or at a first wireless AP that supports indicating critical updates for coordinated access point mechanisms. The operations of the process 1000 may be implemented by a first wireless AP or its components as described herein. For example, the process 1000 may be performed by a wireless communication device, such as the wireless communication device 600 described with reference to FIG. 6, operating as or within a wireless AP. In some examples, the process 1000 may be performed by a wireless AP, such as one of the APs 102 described with reference to FIG. 1.

In some examples, in 1005, the first wireless AP may communicate with a second AP according to a coordinated AP scheme in accordance with one or more parameters associated with the coordinated AP scheme. The operations of 1005 may be performed in accordance with examples as disclosed herein. In some implementations, aspects of the operations of 1005 may be performed by a CAP communication manager 625 as described with reference to FIG. 6.

In some examples, in 1010, the first wireless AP may generate a frame including a set of multiple fields, the set of multiple fields including a field including one of a first value or a second value, the first value of the field being indicative of a change in the one or more parameters associated with the coordinated AP scheme, and a second value of the field being indicative of the one or more parameters associated with the coordinated AP scheme remaining the same. The operations of 1010 may be performed in accordance with examples as disclosed herein. In some implementations, aspects of the operations of 1010 may be performed by a frame generating manager 640 as described with reference to FIG. 6.

In some examples, in 1015, the first wireless AP may transmit the frame, the field including the first value in accordance with a change in the one or more parameters associated with the coordinated AP scheme. The operations of 1015 may be performed in accordance with examples as disclosed herein. In some implementations, aspects of the operations of 1015 may be performed by a frame transmission manager 645 as described with reference to FIG. 6.

In some examples, in 1020, the first wireless AP may communicate with the second AP according to one or more updated parameters associated with the coordinated AP scheme. The operations of 1020 may be performed in accordance with examples as disclosed herein. In some implementations, aspects of the operations of 1020 may be performed by a CAP communication manager 625 as described with reference to FIG. 6.

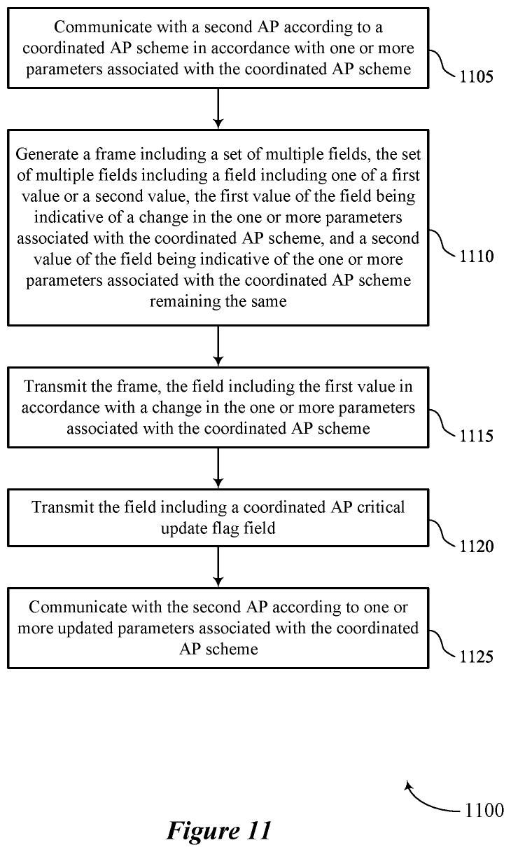

FIG. 11 shows a flowchart illustrating an example process 1100 performable by or at a first wireless AP that supports indicating critical updates for coordinated access point mechanisms. The operations of the process 1100 may be implemented by a first wireless AP or its components as described herein. For example, the process 1100 may be performed by a wireless communication device, such as the wireless communication device 600 described with reference to FIG. 6, operating as or within a wireless AP. In some examples, the process 1100 may be performed by a wireless AP, such as one of the APs 102 described with reference to FIG. 1.

In some examples, in 1105, the first wireless AP may communicate with a second AP according to a coordinated AP scheme in accordance with one or more parameters associated with the coordinated AP scheme. The operations of 1105 may be performed in accordance with examples as disclosed herein. In some implementations, aspects of the operations of 1105 may be performed by a CAP communication manager 625 as described with reference to FIG. 6.

In some examples, in 1110, the first wireless AP may generate a frame including a set of multiple fields, the set of multiple fields including a field including one of a first value or a second value, the first value of the field being indicative of a change in the one or more parameters associated with the coordinated AP scheme, and a second value of the field being indicative of the one or more parameters associated with the coordinated AP scheme remaining the same. The operations of 1110 may be performed in accordance with examples as disclosed herein. In some implementations, aspects of the operations of 1110 may be performed by a frame generating manager 640 as described with reference to FIG. 6.

In some examples, in 1115, the first wireless AP may transmit the frame, the field including the first value in accordance with a change in the one or more parameters associated with the coordinated AP scheme. The operations of 1115 may be performed in accordance with examples as disclosed herein. In some implementations, aspects of the operations of 1115 may be performed by a frame transmission manager 645 as described with reference to FIG. 6.

In some examples, in 1120, the first wireless AP may transmit the field including a coordinated AP critical update flag field. The operations of 1120 may be performed in accordance with examples as disclosed herein. In some implementations, aspects of the operations of 1120 may be performed by a frame transmission manager 645 as described with reference to FIG. 6.

In some examples, in 1125, the first wireless AP may communicate with the second AP according to one or more updated parameters associated with the coordinated AP scheme. The operations of 1125 may be performed in accordance with examples as disclosed herein. In some implementations, aspects of the operations of 1125 may be performed by a CAP communication manager 625 as described with reference to FIG. 6.

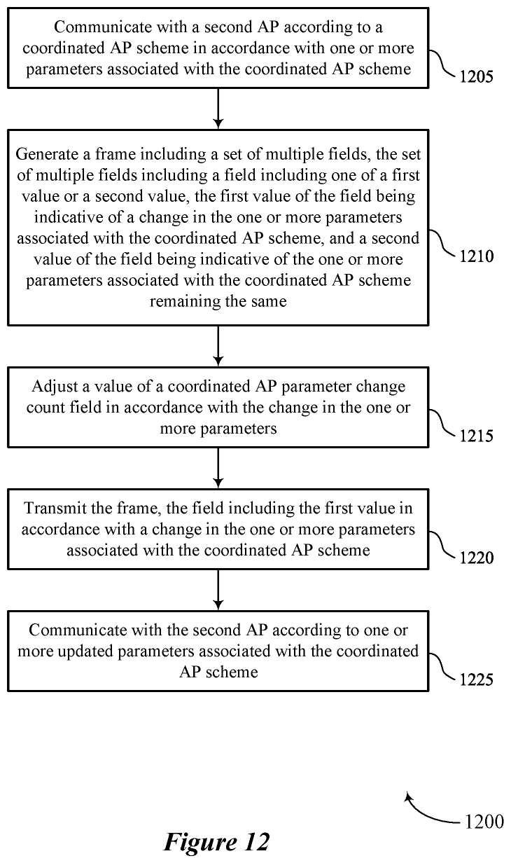

FIG. 12 shows a flowchart illustrating an example process 1200 performable by or at a first wireless AP that supports indicating critical updates for coordinated access point mechanisms. The operations of the process 1200 may be implemented by a first wireless AP or its components as described herein. For example, the process 1200 may be performed by a wireless communication device, such as the wireless communication device 600 described with reference to FIG. 6, operating as or within a wireless AP. In some examples, the process 1200 may be performed by a wireless AP, such as one of the APs 102 described with reference to FIG. 1.

In some examples, in 1205, the first wireless AP may communicate with a second AP according to a coordinated AP scheme in accordance with one or more parameters associated with the coordinated AP scheme. The operations of 1205 may be performed in accordance with examples as disclosed herein. In some implementations, aspects of the operations of 1205 may be performed by a CAP communication manager 625 as described with reference to FIG. 6.

In some examples, in 1210, the first wireless AP may generate a frame including a set of multiple fields, the set of multiple fields including a field including one of a first value or a second value, the first value of the field being indicative of a change in the one or more parameters associated with the coordinated AP scheme, and a second value of the field being indicative of the one or more parameters associated with the coordinated AP scheme remaining the same. The operations of 1210 may be performed in accordance with examples as disclosed herein. In some implementations, aspects of the operations of 1210 may be performed by a frame generating manager 640 as described with reference to FIG. 6.

In some examples, in 1215, the first wireless AP may adjust a value of a coordinated AP parameter change count field in accordance with the change in the one or more parameters. The operations of 1215 may be performed in accordance with examples as disclosed herein. In some implementations, aspects of the operations of 1215 may be performed by a frame generating manager 640 as described with reference to FIG. 6.

In some examples, in 1220, the first wireless AP may transmit the frame, the field including the first value in accordance with a change in the one or more parameters associated with the coordinated AP scheme. The operations of 1220 may be performed in accordance with examples as disclosed herein. In some implementations, aspects of the operations of 1220 may be performed by a frame transmission manager 645 as described with reference to FIG. 6.

In some examples, in 1225, the first wireless AP may communicate with the second AP according to one or more updated parameters associated with the coordinated AP scheme. The operations of 1225 may be performed in accordance with examples as disclosed herein. In some implementations, aspects of the operations of 1225 may be performed by a CAP communication manager 625 as described with reference to FIG. 6.

Implementation examples are described in the following numbered clauses:

Clause 1: A method for wireless communications by a first wireless AP, comprising: communicating with a second AP according to a CAP scheme in accordance with one or more parameters associated with the CAP scheme; receiving a frame comprising a plurality of fields, the plurality of fields including a field comprising one of a first value or a second value, the first value of the field being indicative of a change in the one or more parameters associated with the CAP scheme, and the second value of the field being indicative of the one or more parameters associated with the CAP scheme remaining the same; decoding one or more additional fields of the plurality of fields of the frame in accordance with the field comprising the first value; and communicating with the second AP according to one or more updated parameters associated with the CAP scheme.

Clause 2: The method of clause 1, wherein receiving the frame comprises: receiving the field comprising a CAP-CUF field.

Clause 3: The method of clause 2, wherein receiving the field comprises: receiving the CAP-CUF field via a capabilities information and status indication field of the frame.

Clause 4: The method of any of clauses 2 through 3, wherein receiving the field comprises: receiving, in accordance with the CAP scheme, the CAP-CUF field associated with a first communication link of the first AP and a second communication link of the second AP, the first communication link having one or more first subchannels that at least partially overlap one or more second subchannels of the second communication link.

Clause 5: The method of any of clauses 2 through 3, wherein receiving the field comprises: receiving the CAP-CUF field, the CAP-CUF field being common across one or more communication links associated with the second AP, the one or more communication links associated with the CAP scheme, with one or more other CAP schemes, or both.

Clause 6: The method of any of clauses 1 through 5, wherein receiving the frame comprises: receiving the plurality of fields comprising a CAP-PCC field, a value of the CAP-PCC field being greater than a previous value of the CAP-PCC field in accordance with the change in the one or more parameters.

Clause 7: The method of clause 6, wherein receiving the plurality of fields comprises: receiving the CAP-PCC field via an operations element of the frame or via a reduced neighbor report element of the frame.

Clause 8: The method of any of clauses 6 through 7, wherein receiving the plurality of fields comprises: receiving the CAP-PCC field associated with a first communication link that overlaps at least partially with a second communication link associated with the second AP in accordance with the CAP scheme.

Clause 9: The method of any of clauses 1 through 8, wherein the plurality of fields comprise a set of fields each associated with a respective AP identifier of a corresponding one of a set of APs including the first AP, the plurality of fields comprising a first field associated with a first AP identifier of the first AP, wherein receiving the frame comprises: receiving the first field comprising one of the first value or the second value, the first value of the first field being indicative of the change in the one or more parameters associated with the CAP scheme, and the second value of the first field being indicative of the one or more parameters associated with the CAP scheme remaining the same; and decoding the one or more additional fields of the plurality of fields of the frame in accordance with the first field comprising the first value.

Clause 10: The method of any of clauses 1 through 9, wherein the frame comprises a beacon frame, an extended beacon frame, a probe response frame, or a dedicated CAP advertisement frame.

Clause 11: The method of any of clauses 1 through 10, wherein the one or more parameters comprise parameters associated with one or more of a C-TDMA scheme, a C-SR scheme, a C-RTWT scheme, or another CAP technique.

Clause 12: The method of any of clauses 1 through 11, further comprising: transmitting a second frame comprising a request for the one or more updated parameters.

Clause 13: A method for wireless communications by a first wireless AP, comprising: communicating with a second AP according to a CAP scheme in accordance with one or more parameters associated with the CAP scheme; generating a frame comprising a plurality of fields, the plurality of fields including a field comprising one of a first value or a second value, the first value of the field being indicative of a change in the one or more parameters associated with the CAP scheme, and a second value of the field being indicative of the one or more parameters associated with the CAP scheme remaining the same; transmitting the frame, the field comprising the first value in accordance with a change in the one or more parameters associated with the CAP scheme; and communicating with the second AP according to one or more updated parameters associated with the CAP scheme.

Clause 14: The method of clause 13, wherein transmitting the frame comprises: transmitting the field comprising a CAP-CUF field.

Clause 15: The method of clause 14, wherein transmitting the field comprises: transmitting the CAP-CUF field via a capabilities information and status indication field of the frame.

Clause 16: The method of any of clauses 14 through 15, wherein transmitting the field comprises: transmitting, in accordance with the CAP scheme, the CAP-CUF field associated with a first communication link of the first AP and a second communication link of the second AP, the first communication link having one or more first subchannels that at least partially overlap one or more second subchannels of the second communication link.

Clause 17: The method of any of clauses 14 through 15, wherein

transmitting the field comprises: transmitting the CAP-CUF field, the CAP-CUF field being common across one or more communication links associated with the first AP, the one or more communication links associated with the CAP scheme, with one or more other CAP schemes, or both.

Clause 18: The method of any of clauses 13 through 17, wherein the plurality of fields comprise a CAP-PCC field, the method further comprising: adjusting a value of the CAP parameter change count field in accordance with the change in the one or more parameters.

Clause 19: The method of clause 18, wherein transmitting the frame comprises: transmitting the CAP-PCC field via an operations element of the frame.

Clause 20: The method of any of clauses 18 through 19, wherein transmitting frame comprises: transmitting the CAP-PCC field associated with a first communication link of the first AP and a second communication link of the second AP, the first communication link having one or more first subchannels that at least partially overlap one or more second subchannels of the second communication link.

Clause 21: The method of any of clauses 13 through 20, wherein the plurality of fields comprise a set of fields each associated with a respective AP identifier of a corresponding one of a set of APs including the second AP, the plurality of fields comprising a first field associated with a first AP identifier of the second AP, wherein generating the frame comprises: generating the first field comprising one of the first value or the second value, the first value of the first field being indicative of the change in the one or more parameters associated with the CAP scheme, and the second value of the first field being indicative of the one or more parameters associated with the CAP scheme remaining the same.

Clause 22: The method of any of clauses 13 through 21, wherein the frame comprises a beacon frame, an extended beacon frame, a probe response frame, or a dedicated CAP advertisement frame.

Clause 23: The method of any of clauses 13 through 22, wherein the one or more parameters comprise parameters associated with one or more of a C-TDMA scheme, a C-SR scheme, a C-RTWT scheme, or another CAP technique.

Clause 24: The method of any of clauses 13 through 23, further comprising: receiving a second frame comprising a request for the one or more updated parameters.

Clause 25: A first wireless AP for wireless communications, comprising one or more memories storing processor-executable code, and one or more processors coupled with the one or more memories and individually or collectively operable to execute the code to cause the first wireless AP to perform a method of any of clauses 1 through 12.

Clause 26: A first wireless AP for wireless communications, comprising at least one means for performing a method of any of clauses 1 through 12.

Clause 27: A non-transitory computer-readable medium storing code for wireless communications, the code comprising instructions executable by one or more processors to perform a method of any of clauses 1 through 12.

Clause 28: A first wireless AP for wireless communications, comprising one or more memories storing processor-executable code, and one or more processors coupled with the one or more memories and individually or collectively operable to execute the code to cause the first wireless AP to perform a method of any of clauses 13 through 24.

Clause 29: A first wireless AP for wireless communications, comprising at least one means for performing a method of any of clauses 13 through 24.

Clause 30: A non-transitory computer-readable medium storing code for wireless communications, the code comprising instructions executable by one or more processors to perform a method of any of clauses 13 through 24.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,” or the equivalent in context, whatever it is that is “based on ‘a,” or “based at least in part on ‘a,” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless access point (AP), comprising:
a processing system that includes processor circuitry and memory circuitry that stores code, the processing system configured to cause the first wireless AP to:
communicate with a second AP according to a coordinated AP scheme in accordance with one or more parameters associated with the coordinated AP scheme;
receive a frame comprising a plurality of fields, the plurality of fields including a field comprising one of a first value or a second value, the first value of the field being indicative of a change in the one or more parameters associated with the coordinated AP scheme, and the second value of the field being indicative of the one or more parameters associated with the coordinated AP scheme remaining the same;
decode one or more additional fields of the plurality of fields of the frame in accordance with the field comprising the first value; and
communicate with the second AP according to one or more updated parameters associated with the coordinated AP scheme.

2. The first wireless AP of claim 1, wherein, to receive the frame, the processing system is configured to cause the first wireless AP to:
receive the field comprising a coordinated AP critical update flag field.

3. The first wireless AP of claim 2, wherein, to receive the field, the processing system is configured to cause the first wireless AP to:
receive the coordinated AP critical update flag field via a capabilities information and status indication field of the frame.

4. The first wireless AP of claim 2, wherein, to receive the field, the processing system is configured to cause the first wireless AP to:
receive, in accordance with the coordinated AP scheme, the coordinated AP critical update flag field associated with a first communication link of the first AP and a second communication link of the second AP, the first communication link having one or more first subchannels that at least partially overlap one or more second subchannels of the second communication link.

5. The first wireless AP of claim 2, wherein, to receive the field, the processing system is configured to cause the first wireless AP to:
receive the coordinated AP critical update flag field, the coordinated AP critical update flag field being common across one or more communication links associated with the second AP, the one or more communication links associated with the coordinated AP scheme, with one or more other coordinated AP schemes, or both.

6. The first wireless AP of claim 1, wherein, to receive the frame, the processing system is configured to cause the first wireless AP to:
receive the plurality of fields comprising a coordinated AP parameters change count field, a value of the coordinated AP parameters change count field being greater than a previous value of the coordinated AP parameters change count field in accordance with the change in the one or more parameters.

7. The first wireless AP of claim 6, wherein, to receive the plurality of fields, the processing system is configured to cause the first wireless AP to:
receive the coordinated AP parameters change count field via an operations element of the frame or via a reduced neighbor report element of the frame.

8. The first wireless AP of claim 6, wherein, to receive the plurality of fields, the processing system is configured to cause the first wireless AP to:
receive the coordinated AP parameters change count field associated with a first communication link that overlaps at least partially with a second communication link associated with the second AP in accordance with the coordinated AP scheme.

9. The first wireless AP of claim 1, wherein the plurality of fields comprise a set of fields each associated with a respective AP identifier of a corresponding one of a set of APs including the first AP, the plurality of fields comprising a first field associated with a first AP identifier of the first AP, wherein, to receive the frame, the processing system is configured to cause the first wireless AP to:
receive the first field comprising one of the first value or the second value, the first value of the first field being indicative of the change in the one or more parameters associated with the coordinated AP scheme, and the second value of the first field being indicative of the one or more parameters associated with the coordinated AP scheme remaining the same; and
decode the one or more additional fields of the plurality of fields of the frame in accordance with the first field comprising the first value.

10. The first wireless AP of claim 1, wherein the processing system is further configured to cause the first wireless AP to:
transmit a second frame comprising a request for the one or more updated parameters.

11. A first wireless access point (AP), comprising:
a processing system that includes processor circuitry and memory circuitry that stores code, the processing system configured to cause the first wireless AP to:
communicate with a second AP according to a coordinated AP scheme in accordance with one or more parameters associated with the coordinated AP scheme;
generate a frame comprising a plurality of fields, the plurality of fields including a field comprising one of a first value or a second value, the first value of the field being indicative of a change in the one or more parameters associated with the coordinated AP scheme, and a second value of the field being indicative of the one or more parameters associated with the coordinated AP scheme remaining the same;
transmit the frame, the field comprising the first value in accordance with a change in the one or more parameters associated with the coordinated AP scheme; and
communicate with the second AP according to one or more updated parameters associated with the coordinated AP scheme.

12. The first wireless AP of claim 11, wherein, to transmit the frame, the processing system is configured to cause the first wireless AP to:
transmit the field comprising a coordinated AP critical update flag field.

13. The first wireless AP of claim 12, wherein, to transmit the field, the processing system is configured to cause the first wireless AP to:
transmit the coordinated AP critical update flag field via a capabilities information and status indication field of the frame.

14. The first wireless AP of claim 12, wherein, to transmit the field, the processing system is configured to cause the first wireless AP to:
transmit, in accordance with the coordinated AP scheme, the coordinated AP critical update flag field associated with a first communication link of the first AP and a second communication link of the second AP, the first communication link having one or more first subchannels that at least partially overlap one or more second subchannels of the second communication link; or
transmit the coordinated AP critical update flag field, the coordinated AP critical update flag field being common across one or more communication links associated with the first AP, the one or more communication links associated with the coordinated AP scheme, with one or more other coordinated AP schemes, or both.

15. The first wireless AP of claim 11, wherein the plurality of fields comprise a coordinated AP parameters change count field, and the processing system is further configured to cause the first wireless AP to:
adjust a value of the coordinated AP parameter change count field in accordance with the change in the one or more parameters.

16. The first wireless AP of claim 15, wherein, to transmit the frame, the processing system is configured to cause the first wireless AP to:
transmit the coordinated AP parameters change count field via an operations element of the frame or via a reduced neighbor report element of the frame.

17. The first wireless AP of claim 15, wherein, to transmit frame, the processing system is configured to cause the first wireless AP to:
transmit the coordinated AP parameters change count field associated with a first communication link of the first AP and a second communication link of the second AP, the first communication link having one or more first subchannels that at least partially overlap one or more second subchannels of the second communication link.

18. The first wireless AP of claim 11, wherein the plurality of fields comprise a set of fields each associated with a respective AP identifier of a corresponding one of a set of APs including the second AP, the plurality of fields comprising a first field associated with a first AP identifier of the second AP, wherein, to generate the frame, the processing system is configured to cause the first wireless AP to:
generate the first field comprising one of the first value or the second value, the first value of the first field being indicative of the change in the one or more parameters associated with the coordinated AP scheme, and the second value of the first field being indicative of the one or more parameters associated with the coordinated AP scheme remaining the same.

19. The first wireless AP of claim 11, wherein the processing system is further configured to cause the first wireless AP to:
receive a second frame comprising a request for the one or more updated parameters.

20. A method for wireless communications by a first wireless access point (AP), comprising:
communicating with a second AP according to a coordinated AP scheme in accordance with one or more parameters associated with the coordinated AP scheme;
receiving a frame comprising a plurality of fields, the plurality of fields including a field comprising one of a first value or a second value, the first value of the field being indicative of a change in the one or more parameters associated with the coordinated AP scheme, and the second value of the field being indicative of the one or more parameters associated with the coordinated AP scheme remaining the same;
decoding one or more additional fields of the plurality of fields of the frame in accordance with the field comprising the first value; and
communicating with the second AP according to one or more updated parameters associated with the coordinated AP scheme.
